(19) United States
(12) Patent Application Publication
(10) Pub. No.: US 2022/0144206 A1
(43) Pub. Date: May 12, 2022

(54) SEAT BELT WEARING DETECTION METHOD AND APPARATUS, ELECTRONIC DEVICE, STORAGE MEDIUM, AND PROGRAM

(71) Applicant: Shanghai SenseTime Lingang Intelligent Technology., Ltd., Shanghai (CN)

(72) Inventors: Fei WANG, Shanghai (CN); Chen QIAN, Shanghai (CN)

(21) Appl. No.: 17/585,810

(22) Filed: Jan. 27, 2022

Related U.S. Application Data
(63) Continuation of application No. PCT/CN2020/135494, filed on Dec. 10, 2020.

(30) Foreign Application Priority Data
Aug. 7, 2020 (CN) 202010791309.2

(51) Int. Cl. B60R 22/48; B60W 50/14; G06V 20/59

(52) U.S. Cl. CPC B60R 22/48; B60W 50/14; B60R 2022/4808; B60W 2050/143; G06V 20/593

(57) ABSTRACT

A seat belt wearing detection method includes: a vehicle cabin environment image is acquired; human body detection is performed on the vehicle cabin environment image to obtain human body detection information of at least one human body in a vehicle cabin, and seat belt detection is performed on the vehicle cabin environment image to obtain seat belt detection information of at least one seat belt in the vehicle cabin; the human body detection information of the at least one human body is matched with the seat belt detection information of the at least one seat belt, and a seat belt wearing detection result is determined; and alarm information is sent in a case where any human body is not wearing a seat belt.

### CROSS-REFERENCE TO RELATED APPLICATIONS

The present application is a continuation of International Application No. PCT/CN2020/135494, filed on Dec. 10, 2020, which claims priority to Chinese Patent Application No. 202010791309.2, filed on Aug. 7, 2020. The disclosures of International Application No. PCT/CN2020/135494 and Chinese Patent Application No. 202010791309.2 are hereby incorporated by reference in their entireties.

### BACKGROUND

When a collision or emergency braking occurs during the travelling of a motor vehicle, a strong inertial force is generated, and drivers and passengers can effectively control bodies by wearing seat belts correctly to reduce the physical injury caused by the collision due to the strong inertial force. It can be seen that wearing the seat belts correctly is essential for guaranteeing the life safety of the drivers and the passengers.

In order to provide a safer vehicle cabin environment for the drivers and the passengers, most vehicles are provided with seat belt sensors and alarms. After a determination that the drivers and passengers are seated, whether the seat belts have been buckled can be detected by using the seat belt sensors. When it is detected that a seat belt is not buckled, an alarm can make a sound and flash an icon to remind a driver to fasten the seat belt.

However, many drivers avoid an alarm prompt that the seat belt is not worn by inserting a seat belt buckle into a seat belt socket or by inserting the seat belt into the socket after bypassing it from the back.

### SUMMARY

The present disclosure relates to the technical field of image detection, and in particular to, but not limited to, a seat belt wearing detection method and apparatus, an electronic device, a computer-readable storage medium, and a computer program.

The embodiments of the present disclosure provide a seat belt wearing detection method and apparatus, an electronic device, a computer-readable storage medium, and a computer program.

The embodiments of the present disclosure provide a seat belt wearing detection method. The method may include the following operations. A vehicle cabin environment image may be acquired. Human body detection may be performed on the vehicle cabin environment image to obtain human body detection information of at least one human body in a vehicle cabin, and seat belt detection may be performed on the vehicle cabin environment image to obtain seat belt detection information of at least one seat belt in the vehicle cabin. The human body detection information of the at least one human body may be matched with the seat belt detection information of the at least one seat belt, and a seat belt wearing detection result is determined. In a case where any human body is not wearing a seat belt, alarm information may be sent.

The embodiments of the present disclosure further provide a seat belt wearing detection apparatus. The apparatus may include a memory storing processor-executable instructions and a processor. The processor is configured to execute the stored processor-executable instructions to perform operations of: acquiring a vehicle cabin environment image; performing detection on the vehicle cabin environment image to obtain human body detection information of at least one human body in a vehicle cabin, and performing seat belt detection on the vehicle cabin environment image to obtain seat belt detection information of at least one seat belt in the vehicle cabin; matching the human body detection information of the at least one human body with the seat belt detection information of the at least one seat belt, and determining a seat belt wearing detection result; and in a case where any human body is not wearing a seat belt, sending alarm information.

The embodiments of the present disclosure further provide a non-transitory computer-readable storage medium having stored thereon computer-executable instructions that, when executed by a processor, cause the processor to perform operations of: acquiring a vehicle cabin environment image; performing detection on the vehicle cabin environment image to obtain human body detection information of at least one human body in a vehicle cabin, and performing seat belt detection on the vehicle cabin environment image to obtain seat belt detection information of at least one seat belt in the vehicle cabin; matching the human body detection information of the at least one human body with the seat belt detection information of the at least one seat belt, and determining a seat belt wearing detection result; and in a case where any human body is not wearing a seat belt, sending alarm information.

Reference of effect description of the abovementioned seat belt wearing detection apparatus, electronic device, and computer-readable storage medium is made to the description of the abovementioned seat belt wearing detection method, and will not be elaborated here.

In order to make the abovementioned purposes, characteristics, and advantages of the present disclosure clearer and easier to understand, detailed descriptions will be made below with the embodiments in combination with the drawings.

### BRIEF DESCRIPTION OF THE DRAWINGS

For describing the technical solutions of the embodiments of the present disclosure more clearly, the drawings required to be used in the embodiments will be simply introduced below. The drawings, which are incorporated in and constitute a part of this specification, illustrate embodiments consistent with the present disclosure and, together with the specification, serve to explain the technical solutions of the present disclosure. It is to be understood that the following drawings only illustrate some embodiments of the present disclosure and thus should not be considered as limitation to the scope. Those of ordinary skill in the art may also obtain other related drawings according to these drawings without creative work.

FIG. 1 is a flowchart of a seat belt wearing detection method provided by an embodiment of the present disclosure.

FIG. 2 is a flowchart of determining a seat belt wearing detection result in the seat belt wearing detection method provided by an embodiment of the present disclosure.

FIG. 3 is a schematic structural diagram of the seat belt wearing detection method provided by an embodiment of the present disclosure.

FIG. 4 is a schematic diagram of a seat belt wearing detection apparatus provided by an embodiment of the present disclosure.

FIG. 5 is a schematic diagram of an electronic device provided by an embodiment of the present disclosure.

### DETAILED DESCRIPTION

In order to make the purpose, technical solutions, and advantages of the present disclosure clearer, the technical solutions in the embodiments of the present disclosure are clearly and completely elaborated below in combination with the drawings of the present disclosure. It is apparent that the described embodiments are not all but only part of embodiments of the present disclosure. Components, described and shown herein, of the embodiments of the disclosure may usually be arranged and designed with various configurations. Therefore, the following detailed description of the embodiments of the present disclosure is not intended to limit the scope of protection of the present disclosure, but only represents the selected embodiments of the present disclosure. Based on the embodiments of the present disclosure, all other embodiments obtained by those skilled in the art without creative work shall fall within the scope of protection of the present disclosure.

In a related art, some drivers and passengers escape an alarm prompt that seat belts are not worn by not wearing or incorrectly wearing the seat belts, which brings potential safety hazards to the drivers and passengers.

Based on the abovementioned research, the present disclosure at least provides a seat belt wearing detection method. The method can effectively detect whether a user is wearing a seat belt correctly by combining human body detection and seat belt detection.

The defects existing in the related art are results obtained by the inventor after practice and careful research, thus both the problem discovery process and the solutions proposed for the above problems in the disclosure below shall be the inventor's contribution to the disclosure in the disclosure process.

It is to be noted that similar reference signs and letters represent similar terms in the following drawings and thus a certain term, once being defined in a drawing, are not required to be further defined and explained in subsequent drawings.

In order to facilitate the understanding of the embodiments, a seat belt wearing detection method disclosed in the embodiments of the present disclosure is first introduced in detail.

The execution subject of the seat belt wearing detection method provided by the embodiments of the present disclosure is generally an electronic device with certain computing capacity. The electronic device includes, for example, a terminal device or a server or other processing devices. The terminal device may be User Equipment (UE), a mobile device, a user terminal, a terminal, a cell phone, a cordless phone, a Personal Digital Assistant (PDA), a handheld device, a computing device, a vehicle device, a wearable device, etc. In some implementation modes of the present disclosure, the seat belt wearing detection method may be implemented by means of a processor calling a computer-readable instruction stored in the memory.

The seat belt wearing detection method provided by an embodiment of the present disclosure will be described hereafter.

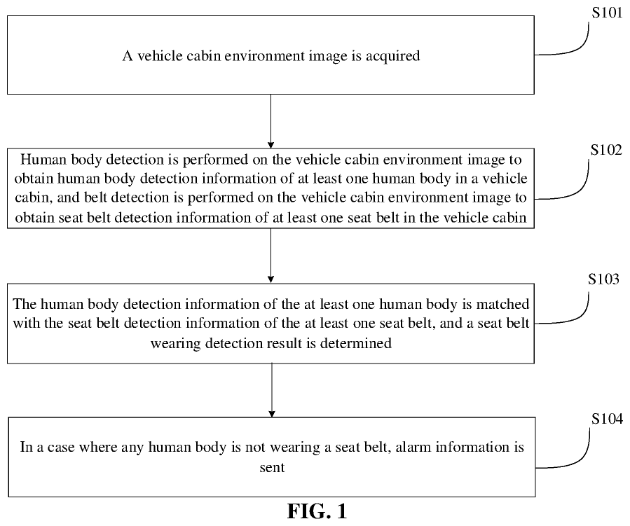

FIG. 1 is a flowchart of a seat belt wearing detection method provided by an embodiment of the present disclosure. Referring to FIG. 1, the method includes S101 to S104.

At S101, a vehicle cabin environment image is acquired.

At S102, human body detection is performed on the vehicle cabin environment image to obtain human body detection information of at least one human body in a vehicle cabin, and belt detection is performed on the vehicle cabin environment image to obtain seat belt detection information of at least one seat belt in the vehicle cabin.

At S103, the human body detection information of the at least one human body is matched with the seat belt detection information of the at least one seat belt, and a seat belt wearing detection result is determined.

At S104, in a case where any human body is not wearing a seat belt, alarm information is sent.

In order to facilitate the understanding of the seat belt wearing detection provided by the embodiment of the present disclosure, the seat belt wearing detection method will be described in detail hereafter. The seat belt wearing detection provided by the embodiment of the present disclosure may be applied to a scenario for detecting seat belt wearing in a vehicle cabin.

In the related art, most vehicles are provided with seat belt sensors and alarms. After a determination that the drivers and the passengers are seated, whether the seat belts have been buckled can be detected by using the seat belt sensors. When it is detected that a seat belt is not buckled, an alarm can make a sound and flash an icon to remind a driver to fasten the seat belt. However, some drivers avoid an alarm prompt that the seat belt is not worn by inserting a seat belt buckle seat belt socket or by inserting the seat belt into the socket after bypassing it from the back. Such behavior is prone to cause a great potential safety hazard.

In addition, although relevant traffic management specifications have been issued for a seat belt wearing behavior, at present, it is mainly based on manual spot check to determine whether the drivers and passengers are wearing the seat belts. However, this manual spot check consumes a lot of human and material resources, and cannot play a good management role for the seat belt wearing behavior.

In order to solve the abovementioned problem, the embodiments of the present disclosure provide a seat belt wearing detection method, which can effectively detect whether a user is wearing a seat belt correctly by combining human body detection and seat belt detection.

The abovementioned vehicle cabin environment image may be photographed by a camera apparatus arranged in a vehicle cabin. In order to photograph image information related to a human body and a seat belt, the camera apparatus here may be arranged facing a seat in the vehicle cabin on the premise of photographing the behavior after a driver or a passenger seats.

In the embodiment of the present disclosure, for the extracted vehicle cabin environment image, on one hand, human body detection may be performed, and on the other hand, seat belt detection may be performed. For the human body detection, human body detection information related to the human body in the vehicle cabin may be determined, for example, human body bounding box information where the human body is located. For the seat belt detection, seat belt detection information related to the seat belt in the vehicle cabin may be determined, for example, seat belt bounding box information where the seat belt is located. It is to be noted that the abovementioned human body detection and seat belt detection may be performed simultaneously.

In the embodiment of the present disclosure, after determination of the human body bounding box information and a seat belt bounding box, the detection of seat belt wearing may be implemented based on the association between the human body and the seat belt.

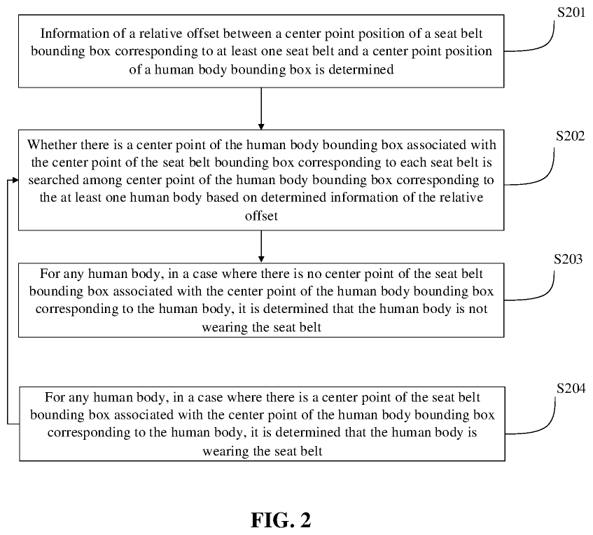

FIG. 2 is a flowchart of determining a seat belt wearing detection result in the seat belt wearing detection method provided by an embodiment of the present disclosure.

As shown in FIG. 2, a process of determining the seat belt wearing detection result may be implemented through S201 to S204.

At S201, information of a relative offset between a center point position of a seat belt bounding box corresponding to at least one seat belt and a center point position of a human body bounding box is determined.

At S202, whether there is a center point of the human body bounding box associated with the center point of the seat belt bounding box corresponding to each seat belt is searched among center point of the human body bounding box corresponding to the at least one human body based on determined information of the relative offset.

At S203, for any human body, in a case where there is no center point of the seat belt bounding box associated with the center point of the human body bounding box corresponding to the human body, it is determined that the human body is not wearing the seat belt.

At S204, for any human body, in a case where there is a center point of the seat belt bounding box associated with the center point of the human body bounding box corresponding to the human body, it is determined that the human body is wearing the seat belt.

Here, the information of the relative offset between the center point position of the seat belt bounding box and the center point position of the human body bounding box may be determined by using a human body center point offset network that is trained in advance.

In the embodiment of the present disclosure, before training the network, a center position of the seat belt may be subjected to pixel point labeling in advance, and a center position of the human body corresponding to the seat belt is subjected to pixel point labeling. Network parameters of the abovementioned human body center point offset network may be trained based on the abovementioned labeling information.

Here, the information of the relative offset corresponding to each human body may be determined based on the network parameters obtained by training. Whether there is a center point of the human body bounding box associated with the center point of the seat belt bounding box corresponding to each seat belt may be searched among the center point of at least one human body bounding box in combination with the information of the relative offset and the center point position of the seat belt bounding box. That is, after the information of the relative offset and the center point position of the seat belt bounding box are determined, the human body bounding box associated with the seat belt bounding box may be determined.

In the embodiment of the present disclosure, for any human body, if the seat belt bounding box associated with the human body bounding box of the human body cannot be found, it indicates that the human body is not wearing a seat belt, and if the seat belt bounding box associated with the human body bounding box of the human body is found, it indicates that the human body is wearing a seat belt.

In specific application, when it is determined that any human body is not wearing a seat belt, the seat belt wearing detection method provided by the embodiment of the present disclosure can also send alarm information indicating that a user is not wearing a seat belt through a vehicle terminal or a driver end, so as to remind the drivers and passengers to wear the seat belt correctly and ensure the driving safety of a vehicle.

Considering that the human body is wearing the seat belt correctly, there is a strong spatial relationship between human body detection information and seat belt detection information. Therefore, whether a detected human body is wearing the seat belt may be determined by matching the two types of detection information (i.e., the human body detection information and the seat belt detection information) here.

It is to be noted that, in the embodiment of the present disclosure, feature extraction may be performed on the acquired vehicle cabin environment image first before performing the human body detection and the seat belt detection, so as to obtain a vehicle cabin feature map. Here, the vehicle cabin environment image may be directly processed based on an image processing method, so as to extract out vehicle cabin related features (for example, a scenario feature and an object contour feature), and features may also be extracted from the vehicle cabin environment image based on a feature extraction network that is trained in advance, so as to obtain a vehicle cabin feature map.

Considering that richer and deeper hidden features can be mined by using the feature extraction network, the embodiment of the present disclosure can use the feature extraction network to realize feature extraction.

In some embodiments of the present disclosure, the feature extraction network may be obtained by training based on a Backbone network. The Backbone network, as a Convolutional Neural Networks (CNN), can train the correlation between an input image and an output feature by using the convolution property of the CNN.

Thus, the acquired vehicle cabin environment image is input into a trained feature extraction network, and the input vehicle cabin environment image may be subjected to a convolution operation for at least one time, so as to extract a corresponding vehicle cabin feature map.

In some embodiments of the present disclosure, for an input vehicle cabin environment image with the size of 640*480, a dimension-reduced vehicle cabin feature map with the size of the 80*60*C may be reduced after passing through the feature extraction network. Herein, C is the number of channels, and each channel may correspond to a vehicle cabin feature in one dimension.

Considering the key role of the human body detection and the seat belt detection in the seat belt wearing detection method provided by the embodiment of the present disclosure, description may be made next by determining human body bounding box information and determining seat belt bounding box information.

In some embodiments of the present disclosure, in a case where the human body bounding box information is taken as the human body detection information, the embodiment of the present disclosure may extract a multichannel feature map related to a human body first, and then the human body bounding box information is determined based on the multichannel feature map, which may include SA1 to SA2 specifically.

At SA1, human body detection is performed on a vehicle cabin feature map to obtain a multichannel feature map corresponding to each of at least one human body in a vehicle cabin, and the multichannel feature map includes a human body center point feature map, a human body length feature map, and a human body width feature map.

At SA2, human body bounding box information corresponding to the at least one human body is determined based on the multichannel feature map. The human body bounding box information includes center point position information of the human body bounding box and size information of the human body bounding box.

Here, the multichannel feature map related to the human body may be extracted based on a trained human body detection network. Similar to the abovementioned feature extraction network, the human body detection network here may also be obtained by training based on the CNN. Different from the abovementioned feature extraction network, the human body detection network here trains the correlation between vehicle cabin features and human body features. Thus, the vehicle cabin feature map is input into a trained human body detection network, and the input vehicle cabin feature map may be subjected to a convolution operation for at least one time, so as to extract a multichannel feature map corresponding to each human body.

The multichannel feature map includes a human body center point feature map, and each included human body center point feature value may represent the probability that each corresponding pixel point belongs to a human body center point. The larger the human body center point feature value, the higher the probability of the corresponding human body center point. On the contrary, the smaller the human body center point feature value, the lower the probability of the corresponding human center point. In addition, the human body length feature map and the human body width feature map included in the multichannel feature map may represent the length information and the width information of the human body.

It is to be noted that in order to facilitate implementing subsequent positioning of a position related to the human body center position, the size of the multichannel feature map here may be the same as that of the vehicle cabin feature map. Here, taking the multichannel feature map as a three-channel feature map as an example, a three-channel feature map of 80*60*3 may be obtained after passing through the human body detection network.

In some embodiments of the present disclosure, the process that the human body bounding box information including the center point position information of the human body bounding box and the size information of the human body bounding box may be determined based on the multichannel feature map may include SB1 to SB4 specifically.

At SB1, for the human body center point feature map included in the multichannel feature map, human body center point feature sub-maps to be pooled are successively intercepted from the human body center point feature map according to a preset pooling size and a preset pooling step size.

At SB2, for each of the human body center point feature sub-maps intercepted successively, maximum pooling processing is performed on the human body center point feature sub-map to determine a maximum human body center point feature value of respective human body center point feature values corresponding to the human body center point feature sub-map, and coordinate position information of the maximum human body center point feature value in the human body center point feature map.

At SB3, the center point position information of the human body bounding box corresponding to at least one human body is determined based on the maximum human body center point feature values respectively corresponding to the human body center point feature sub-maps and the coordinate position information of the maximum human body center point feature values in the human body center point feature map.

At SB4, human body length information and human body width information matching the human body bounding box are respectively determined from the human body length feature map and the human body width feature map included in the multichannel feature map based on the center point position information of each human body bounding box. Determined human body length information and determined human body width information are taken as the size information of the human body bounding box.

Here, considering that the magnitude of each human body center point feature value corresponding to the human body center point feature map directly affects possibility that the corresponding pixel point is taken as the human body center point. That is, the larger the feature value, the higher the possibility of being determined as the human body center point, and vice versa. Therefore, the embodiments of the present disclosure provide a solution of performing maximum pooling processing first to find a pixel point most likely to be the center point of the human body center point according to a processing result, and then determining the center point position information of the human body bounding box corresponding to the human body.

In some embodiments of present disclosure, the human body center point feature sub-maps may be successively intercepted from the human body center point feature map according to the preset pooling size and the preset pooling step size. For example, taking the human body center point feature map with the size of 80*60 as an example, human body center point feature sub-maps of 80*60 may be obtained after the sub-maps are intercepted according to the preset pooling size of 3*3 and the preset pooling step size 1.

For each of the human body center point feature sub-maps intercepted successively, the maximum human body center point feature value of respective human body center point feature values corresponding to the human body center point feature sub-maps may be determined, that is, a maximum human body center point feature value may be determined for each human center point feature sub-map through the maximum pool processing. Thus, the coordinate position information of the maximum human body center point feature value in the human body center point feature map may be determined based on the coordinate position of the maximum human body center point feature value in the human body center point feature map and the coordinate range where the human body center point feature sub-map is located in the human body center point feature map. The coordinate position information represents the position of the human body center point to a great extent, the center point position information of the human body bounding box corresponding to the human body may be determined based on the coordinate position information.

In some embodiments of the present disclosure, in order to further improve the accuracy of human body center point detection, the maximum human body center point feature value that is more consistent with the human body center point may be selected from respective maximum human body center point feature values obtained in a threshold value setting mode. Illustratively, whether the maximum human body center point feature value corresponding to a human body center point feature sub-map is greater than a preset threshold value may be determined first. In a case where the maximum human body center point feature value is greater than the preset threshold value, the human body center point indicated by the maximum human body center point feature value may be determined as a target human body center point. The coordinate position information corresponding to the target human body center point may be determined as the center point position information of the human body bounding box. On the contrary, in a case where the maximum human body center point feature value is less than or equal to the preset threshold value, then an assignment operation is not performed on the coordinate position information of the target human body center point.

The abovementioned preset threshold value should not be too large or too small. A too large threshold value may lead to missed detection of a human body, and a too small threshold value may lead to excessive detection. Therefore, too large or too small preset threshold value cannot ensure the accuracy of the human body detection. The embodiment of the present disclosure may select different preset threshold values in combination with specific application scenarios, which is not limited herein.

It is to be noted that, for different human body center point feature sub-maps, the coordinate position information of the maximum human body center point feature value in the human body center point feature map may be the same. In some embodiments of the present disclosure, in order to reduce subsequent calculation amount, information merging may be performed.

In some embodiments of the present disclosure, in order to facilitate pooling processing, for the human body center point feature map representing the human body center point position, normalization processing may be performed on the human body center point feature map by using a sigmoid activation function first, and then the human body center point feature sub-maps are intercepted successively from the normalized human body center point feature map. Here, the sigmoid activation function may transform respective human body center point feature values corresponding to the human body center point feature map into numerical values between 0 and 1.

In some embodiments of the present disclosure, in a case where the center point position information of the human body bounding box is determined, the human body length information and the human body width information matching the center point position information of the human body bounding box may be searched among the human body length feature map and the human body width feature map based on the same center point position information, so as to determine the size information of the human body bounding box.

In some embodiments of the present disclosure, in a case where seat belt bounding box information is taken as seat belt detection information, the determination of the seat belt bounding box information may be implemented in combination with seat belt category identification, seat belt center offset determination, and pixel point clustering, which may include SC1 to SC3.

At SC1, the seat belt category information of each of a plurality of pixel points included in the vehicle cabin feature map may be determined, where seat belt category information includes indication whether or not the pixel point belongs to the seat belt; and a pixel point of which the seat belt category information indicates that the pixel point belongs to the seat belt is determined as a target seat belt pixel point.

At SC2, information of a relative offset between each target seat belt pixel point and a seat belt center pixel point is determined. The seat belt center pixel point corresponding to each target seat belt pixel point is determined based on the information of the relative offset.

At SC3, a plurality of target seat belt pixel points corresponding to the same seat belt center pixel point are clustered based on the seat belt center pixel point, so as to obtain the seat belt bounding box information corresponding to at least one seat belt in the vehicle cabin. The seat belt bounding box information includes center point detection information of the seat belt bounding box.

Here, in the seat belt wearing detection method provided by the embodiments of the present disclosure, first, the seat belt category information related to a seat belt may be extracted, then, the seat belt center pixel point corresponding to each target seat belt pixel point belonging to the category of seat belt is determined by using a seat belt center point offset network, and finally, the target seat belt pixel points are clustered based on the seat belt center pixel points, so as to determine the center point position information of the seat belt bounding box.

In some embodiments of the present disclosure, the abovementioned operation of extracting the seat belt category information related to the seat belt may be implemented by a semantic segmentation network. The abovementioned semantic segmentation network may be obtained by training based on a training sample set labeled with the seat belt category. The labeling here may adopt a method of labeling pixel by pixel. That is, for any training sample, the seat belt category of each pixel point included in the training sample may be labeled. Thus, the seat belt category information of each of the plurality of pixel points included in the vehicle cabin feature map can be determined through the learning of network parameters.

In some embodiments of the present disclosure, the abovementioned semantic segmentation network, as a binary classification model, may determine a two-channel feature map including a background feature map and a seat belt feature map. Thus, for each pixel point in the vehicle cabin feature map, the seat belt category of each pixel point may be determined based on the seat belt category information indicated by a larger feature value of the feature values respectively corresponding to the pixel points in the background feature map and the seat belt feature map, that is, the larger the feature value, the higher the probability of the corresponding category, so that the category with higher probability may be selected form two preset categories.

In some embodiments of the present disclosure, taking a vehicle cabin feature map of 80*60*C as an example, a two-channel feature map of 80*60*2 may be obtained after passing through the semantic segmentation network. The category corresponding to the pixel point may be determined by traversing each pixel point in the feature map with the size of 80*60 and getting the seat belt category corresponding to the dimension with the largest score in the channel.

In some embodiments of the present disclosure, the operations of traversing each pixel point in the feature map with the size of 80*60 and getting the seat belt category corresponding to the dimension with the largest score in the channel may be implemented by performing softmax calculation on a feature vector of each dimension of the feature map.

In some embodiments of the present disclosure, after the seat belt category information of each pixel point included in the vehicle cabin feature map is determined, the information of the relative offset corresponding to the target seat belt pixel belonging to the seat belt category may be determined by using the seat belt center point offset network, and then the seat belt center pixel point corresponding to each target seat belt pixel point may be determined.

In some embodiments of the present disclosure, the abovementioned seat belt center point offset network trains the information of the relative offset between the seat belt pixel point and the seat belt point center pixel. Before the network is trained, the pixel point labeling is performed on an image area where one seat belt is located in advance, and the pixel point labeling is performed on a center position of one seat belt, and network parameters of the abovementioned seat belt center point offset network may be trained based on the abovementioned labeling information.

In some embodiments of the present disclosure, the information of the relative offset corresponding to each target seat belt pixel point may be determined based on the network parameters obtained by training, and the seat belt center pixel point corresponding to the target seat belt pixel point may be determined in combination with the information of the relative offset and the position of the target seat belt pixel point.

Illustratively, taking the two-channel feature map of 80*60*2 as an example, each pixel point in the feature map with the size of 80*60 may be traversed, and a two-channel offset feature map of 80*60*2 may be obtained after the operation of the seat belt center point offset network. Two channels respectively represent the information of the relative offset in two directions, so as to determine final information of the relative offset.

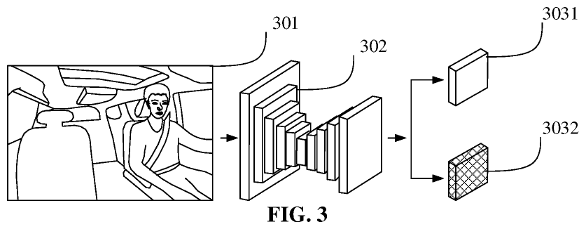

FIG. 3 is a schematic structural diagram of the seat belt wearing detection method provided by an embodiment of the present disclosure.

In some embodiments of the present disclosure, a vehicle cabin environment image 301 may include a seating state of drivers and passengers in a vehicle cabin. When there are a plurality of drivers and passengers, the vehicle cabin environment image 301 may include a seating state of each driver and passenger.

In some embodiments of the present disclosure, a neural network 302 may be a feature extraction network as described in the foregoing embodiment, for example, the trained human body detection network and the semantic segmentation network as described in the foregoing embodiment. In the embodiment of the present disclosure, the neural network 302 may also be the Backbone as described in the foregoing embodiment.

In some embodiments of the present disclosure, the vehicle cabin environment image 301 is input into the neural network 302, a three-channel feature map 3031 of 80*60*3, and a two-channel feature map 3032 of 80*60*2 as described in the foregoing embodiment may be obtained after a feature extraction operation of the neural network 302 on the vehicle cabin environment image 301.

Illustratively, according to the mode provided by the foregoing embodiment, pooling processing is performed on the three-channel feature map 3031, so that a seat belt bounding box center point position corresponding to at least one seat belt may be obtained. Illustratively, according to the mode provided by the foregoing embodiment, the information of the relative offset between the seat belt bounding box center point position and the human body bounding box center point position may be determined based on the two-channel feature map 3032. Based on the mode provided by the foregoing embodiment, a seat belt wearing detection result may be determined through the center point position information and the information of the relative offset.

In some embodiments of the present disclosure, the seat belt center pixel points corresponding to different target seat belt pixel points may be the same or may be different, and the seat belt bounding box information corresponding to each seat belt may be obtained by clustering the plurality of target seat belt pixel points corresponding to the same seat belt center pixel point.

The seat belt bounding box information here may include center point position information of a seat belt bounding box (corresponding to the seat belt center pixel point). In addition, the seat belt bounding box information may also include size information of the seat belt bounding box. The size information may also be determined by an image area where the plurality of target seat belt pixel points obtained by clustering the seat belt center pixel points are located.

It can be understood by those skilled in the art that, in the above-mentioned method of the specific implementation modes, the writing sequence of each step does not mean a strict execution sequence and is not intended to form any limitation to the implementation process and a specific execution sequence of each step should be determined by functions and probable internal logic thereof.

Based on the same inventive conception, the embodiments of the present disclosure further provide a seat belt wearing detection apparatus corresponding to the seat belt wearing detection method. The principle of the apparatus in the embodiments of the present disclosure for solving the problem is similar to the abovementioned seat belt wearing detection method of the embodiments of the present disclosure, so implementation of the apparatus may refer to implementation of the method. Repeated parts will not be elaborated.

The embodiments of the present disclosure further provide a seat belt wearing detection apparatus 4.

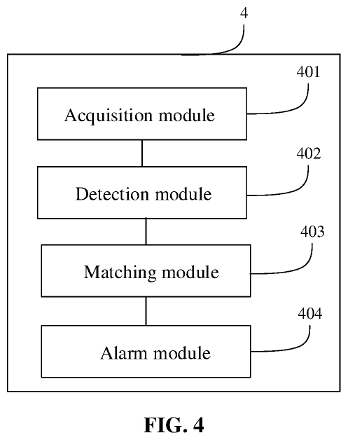

FIG. 4 is a schematic diagram of a seat belt wearing detection apparatus provided by an embodiment of the present disclosure. Referring to FIG. 4, the seat belt wearing detection apparatus 4 may include: an information acquisition module 401, a detection module 402, a matching module 403, and an alarm module 404.

The acquisition module 401 is configured to: acquire a vehicle cabin environment image.

The detection module 402 is configured to: detect the vehicle cabin environment image to obtain human body detection information of at least one human body in a vehicle cabin, and perform seat belt detection on the vehicle cabin environment image to obtain seat belt detection information of at least one seat belt in the vehicle cabin.

The matching module 403 is configured to: match the human body detection information of the at least one human body with the seat belt detection information of the at least one seat belt to determine a seat belt wearing detection result.

The alarm module 404 is configured to: send alarm information in a case where any human body is not wearing a seat belt.

By the abovementioned seat belt wearing detection apparatus, firstly, a vehicle cabin feature map may be generated based on the acquired vehicle cabin environment image, and human body detection and seat belt detection are respectively performed on the vehicle cabin feature map to obtain human body detection information and seat belt detection information. Considering that when the human body is actually wearing the seat belt, there is a certain position corresponding relationship between the human body and the seat belt, so whether the human body is wearing the seat belt can be detected by matching the abovementioned human body detection information and seat belt detection information, which realizes effective detection of a seat belt wearing behavior.

In some embodiments of the present disclosure, the matching module 403 is configured to: match the human body detection information of the at least one human body with the seat belt detection information of the at least one seat belt according to the following steps.

Information of a relative offset between a center point position of a seat belt bounding box corresponding to the at least one seat belt and a center point position of a human body bounding box is determined.

Whether there is a center point of the human body bounding box associated with the center point of the seat belt bounding box corresponding to each seat belt is searched among center point of the human body bounding box corresponding to the at least one human body based on determined information of the relative offset.

In some embodiments of the present disclosure, the matching module 403 is configured to: determine the seat belt wearing detection result according to the following steps.

For any human body, in a case where there is no center point of the seat belt bounding box associated with the center point of the human body bounding box corresponding to the human body, it is determined that the human body is not wearing the seat belt.

In some embodiments of the present disclosure, the matching module 403 is configured to: determine the seat belt wearing detection result according to the following steps.

For any human body, in a case where there is a center point of the seat belt bounding box associated with the center point of the human body bounding box corresponding to the human body, it is determined that the human body is wearing the seat belt.

In some embodiments of the present disclosure, the human body detection information includes human body bounding box information. The detection module 402 is configured to: perform human body detection on the vehicle cabin environment image to obtain the human body detection information of the at least one human body in the vehicle cabin according to the following steps.

A vehicle cabin feature map is generated based on the vehicle cabin environment image.

The human body detection is performed on the vehicle cabin feature map to obtain a multichannel feature map corresponding to each of the at least one human body in the vehicle cabin. The multichannel feature map includes a human body center point feature map, a human body length feature map, and a human body width feature map.

Human body bounding box information corresponding to the at least one human body is determined based on the multichannel feature map. The human body bounding box information includes center point position information of the human body bounding box and size information of the human body bounding box.

In some embodiments of the present disclosure, the detection module 402 is configured to: determine the human body bounding box information corresponding to the at least one human body based on the multichannel feature map according to the following steps.

For the human body center point feature map included in the multichannel feature map, human body center point feature sub-maps to be pooled are successively intercepted from the human body center point feature map according to a preset pooling size and a preset pooling step size.

For each of the human body center point feature sub-maps intercepted successively, maximum pooling processing is performed on the human body center point feature sub-map to determine a maximum human body center point feature value of respective human body center point feature values corresponding to the human body center point feature sub-map, and coordinate position information of the maximum human body center point feature value in the human body center point feature map.

The center point position information of the human body bounding box corresponding to at least one human body is determined based on the maximum human body center point feature values respectively corresponding to the human body center point feature sub-maps and the coordinate position information of the maximum human body center point feature values in the human body center point feature map.

Human body length information and human body width information matching the human body bounding box are respectively determined from the human body length feature map and the human body width feature map included in the multichannel feature map based on the center point position information of each of the human body bounding boxes. Determined human body length information and determined human body width information are taken as the size information of the human body bounding box.

In some embodiments of the present disclosure, the detection module 402 is configured to: successively intercept the human body center point feature sub-maps to be pooled from the human body center point feature map according to the preset pooling size and the preset pooling step size according to the following steps.

Normalization processing is performed on the human body center point feature map representing a human body center point position by using an activation function, so as to obtain a normalized human body center point feature map.

The human body center point feature sub-maps to be pooled are successively intercepted from the normalized human body center point feature map according to the preset pooling size and the preset pooling step size.

In some embodiments of the present disclosure, the detection module 402 is configured to: determine the center point position information of the human body bounding box corresponding to the at least one human body according to the following steps.

For each of the human body center point feature sub-maps, whether the maximum human body center point feature value corresponding to the human body center point feature sub-map is greater than a preset threshold value is determined.

In a case where the maximum human body center point feature value corresponding to the human body center point feature sub-map is greater than a preset threshold value, the human body center point indicated by the maximum human body center point feature value is determined as a target human body center point.

The center point position information of the human body bounding box corresponding to the at least one human body is determined based on coordinate position information of each target human body center point in the human body center point feature map.

In some embodiments of the present disclosure, the seat belt detection information includes the seat belt bounding box information. The detection module 402 is configured to: perform seat belt detection on the vehicle cabin environment image to obtain the seat belt detection information of at least one seat belt in the vehicle cabin according to the following steps.

A vehicle cabin feature map is generated based on the vehicle cabin environment image.

The seat belt category information of each of a plurality of pixel points included in the vehicle cabin feature map is determined, where the seat belt category information includes indication whether or not the pixel point belongs to the seat belt; and a pixel point of which the seat belt category information indicates that the pixel point belongs to the seat belt is determined as a target seat belt pixel point.

Information of a relative offset between each target seat belt pixel point and a seat belt center pixel point is determined. The seat belt center pixel point corresponding to each target seat belt pixel point is determined based on the information of the relative offset.

A plurality of target seat belt pixel points corresponding to the same seat belt center pixel point are clustered based on the seat belt center pixel point, so as to obtain the seat belt bounding box information corresponding to at least one seat belt in the vehicle cabin. The seat belt bounding box information includes center point detection information of the seat belt bounding box.

In some embodiments of the present disclosure, the detection module 402 is configured to: determine the seat belt category information of each of the plurality of pixel points included in the vehicle cabin feature map according to the following steps.

Seat belt detection is performed on the vehicle cabin feature map to obtain a two-channel feature map. The two-channel feature map includes a background feature map and a seat belt feature map.

For each of the plurality of pixel points included in the vehicle cabin feature map, the seat belt category information indicated by a larger feature value of the feature values respectively corresponding to the pixel point in the background feature map and the seat belt feature map is determined as the seat belt category information of the pixel point.

The descriptions about the processing flow of each module in the apparatus and interaction flows between various modules may refer to the related descriptions in the abovementioned method embodiment, and will not be elaborated herein.

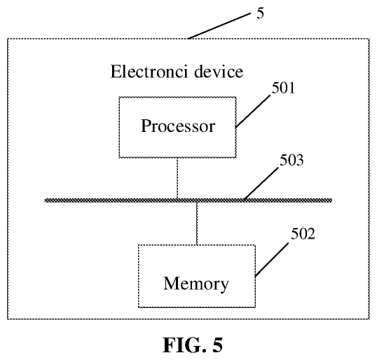

The embodiments of the present disclosure further provide an electronic device 5. FIG. 5 is a schematic diagram of an electronic device provided by an embodiment of the present disclosure. As shown in FIG. 5, the electronic device includes: a processor 501, a memory 502, and a bus 503. The memory 502 stores a machine-readable instruction executable for the processor 501 (for example, execution instructions corresponding to the acquisition module 401, the detection module 402, the matching module 403, and the alarm module 404 in the seat belt wearing detection apparatus of FIG. 4). When the electronic device runs, the processor 501 communicates with the memory 502 through the bus 503. When the machine-readable instruction is executed by the processor 501, the following processing is performed.

Human body detection is performed on the vehicle cabin environment image to obtain human body detection information of at least one human body in a vehicle cabin, and belt detection is performed on the vehicle cabin environment image to obtain seat belt detection information of at least one seat belt in the vehicle cabin. The human body detection information of the at least one human body is matched with the seat belt detection information of the at least one seat belt, and a seat belt wearing detection result is determined. In a case where any human body is not wearing a seat belt, alarm information is sent.

A specific execution process of the abovementioned instruction may refer to the seat belt wearing detection method in the embodiments of the disclosure, and will not be elaborated herein.

The embodiments of the present disclosure further provide a computer-readable storage medium, in which a computer program is stored. When run by a processor, the computer program executes the seat belt wearing detection method as described in the abovementioned method embodiment. The computer-readable storage medium may be a nonvolatile or volatile computer readable storage medium.

A computer program product of the seat belt wearing detection method provided in the embodiments of the present disclosure includes a computer-readable storage medium, in which a program code is stored. An instruction included in the program code may be configured to execute the seat belt wearing detection method as described in the abovementioned method embodiment. References may be made to the abovementioned method embodiment and will not be elaborated herein.

The embodiments of the present disclosure further provide a computer program. The computer program includes a computer-readable code. In a case where the computer-readable code runs in the electronic device, a processor of the electronic device is configured to execute the seat belt wearing detection method as described in any one of the foregoing embodiments. The computer program product may be specifically realized by means of hardware, software or a combination thereof. In some embodiments of the present disclosure, the computer program product is specifically embodied as a computer storage medium, and in some embodiments of the present disclosure, the computer program product is specifically embodied as software products, such as a Software Development Kit (SDK).

Those skilled in the art may clearly learn about that specific working processes of the system and apparatus described above may refer to the corresponding processes in the method embodiment and will not be elaborated herein for convenient and brief description. In the several embodiments provided in the present disclosure, it should be understood that the disclosed system, apparatus, and method may be implemented in other modes. The apparatus embodiment described above is only schematic, and for example, division of the units is only logic function division, and other division modes may be adopted during practical implementation. For another example, a plurality of units or components may be combined or integrated into another system, or some characteristics may be neglected or not executed. In addition, the displayed or discussed mutual couplings or direct couplings or communication connections may be implemented through some communications interfaces. The indirect couplings or communication connections between the apparatuses or modules may be implemented in electrical, mechanical, or other forms.

The units described as separate parts may or may not be physically separated, and parts displayed as units may or may not be physical units, and namely may be located in the same place, or may also be distributed to multiple network units. Some or all of the units may be selected based on actual requirements to achieve the objectives of the solutions of the embodiments. In addition, each functional unit in each embodiment of the present disclosure may be integrated into a processing unit, each unit may also physically exist independently, and two or more than two units may also be integrated into a unit.

When the functions are implemented in a form of a software functional unit and sold or used as an independent product, the functions may be stored in a non-volatile computer-readable storage medium executable for the processor. Based on such an understanding, the technical solutions of the present disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device, or the like) to execute all or part of the steps of the method in each embodiment of the present disclosure. The foregoing storage medium includes: various media capable of storing program codes, such as a USB flash disc, a mobile hard disc, a Read-Only Memory (ROM), a Random Access Memory (RAM), a magnetic disc, or a compact disc.

It is finally to be noted that the above embodiments are only the specific implementation modes of the present disclosure and are adopted not to limit the present disclosure but to describe the technical solutions of the present disclosure. The scope of protection of the present disclosure is not limited thereto. Although the present disclosure is described with reference to the embodiments in detail, those of ordinary skill in the art should know that those skilled in the art may still make modifications or apparent variations to the technical solutions recorded in the embodiments or make equivalent replacements to part of technical features within the technical scope disclosed in the present disclosure, and these modifications, variations, or replacements do not make the essence of the corresponding technical solutions departs from the spirit and scope of the technical solutions of the embodiments of the present disclosure and shall fall within the scope of protection of the present disclosure. Therefore, the scope of protection of the present disclosure shall be subject to the scope of protection of the claims.

### INDUSTRIAL APPLICABILITY

The embodiments of the present disclosure disclose a seat belt wearing detection method and apparatus, an electronic device, a storage medium, and a program. The method includes: a vehicle cabin environment image is acquired; detection is performed on the vehicle cabin environment image to obtain human body detection information of at least one human body in a vehicle cabin, and seat belt detection is performed on the vehicle cabin environment image to obtain seat belt detection information of at least one seat belt in the vehicle cabin; and the human body detection information of the at least one human body is matched with the seat belt detection information of the at least one seat belt, and a seat belt wearing detection result is determined. The seat belt wearing detection method provided by the embodiments of the present disclosure can accurately detect a wearing state of drivers and passengers in a vehicle cabin environment.

1. A seat belt wearing detection method, comprising:
acquiring a vehicle cabin environment image;
performing detection on the vehicle cabin environment image to obtain human body detection information of at least one human body in a vehicle cabin, and performing seat belt detection on the vehicle cabin environment image to obtain seat belt detection information of at least one seat belt in the vehicle cabin;
matching the human body detection information of the at least one human body with the seat belt detection information of the at least one seat belt, and determining a seat belt wearing detection result; and
in a case where any human body is not wearing a seat belt, sending alarm information.

2. The method of claim 1, wherein matching the human body detection information of the at least one human body with the seat belt detection information of the at least one seat belt comprises:
determining information of a relative offset between a center point position of a seat belt bounding box corresponding to the at least one seat belt and a center point position of a human body bounding box; and
searching whether there is a center point of the human body bounding box associated with the center point of the seat belt bounding box corresponding to each seat belt among the center point of the human body bounding box corresponding to the at least one human body based on determined information of the relative offset.

3. The method of claim 2, wherein determining the seat belt wearing detection result comprises:
for any human body, in a case where there is no center point of the seat belt bounding box associated with the center point of the human body bounding box corresponding to the human body, determining that the human body is not wearing the seat belt.

4. The method of claim 2, wherein determining the seat belt wearing detection result comprises:
for any human body, in a case where there is a center point of the seat belt bounding box associated with the center point of the human body bounding box corresponding to the human body, determining that the human body is wearing the seat belt.

5. The method of claim 1, wherein the human body detection information comprises human body bounding box information; and performing detection on the vehicle cabin environment image to obtain the human body detection information of the at least one human body in the vehicle cabin comprises:
generating a vehicle cabin feature map based on the vehicle cabin environment image;
performing human body detection on the vehicle cabin feature map to obtain a multichannel feature map corresponding to each of at least one human body in the vehicle cabin, wherein the multichannel feature map comprises a human body center point feature map, a human body length feature map, and a human body width feature map; and
determining the human body bounding box information corresponding to the at least one human body based on the multichannel feature map, wherein the human body bounding box information comprises center point position information of the human body bounding box and size information of the human body bounding box.

6. The method of claim 5, wherein determining the human body bounding box information corresponding to the at least one human body based on the multichannel feature map comprises:
for the human body center point feature map comprised in the multichannel feature map, successively intercepting human body center point feature sub-maps to be pooled from the human body center point feature map according to a preset pooling size and a preset pooling step size;
for each of the human body center point feature sub-maps intercepted successively, performing maximum pooling processing on the human body center point feature sub-map to determine a maximum human body center point feature value of respective human body center point feature values corresponding to the human body center point feature sub-map, and coordinate position information of the maximum human body center point feature value in the human body center point feature map;
determining the center point position information of the human body bounding box corresponding to at least one human body based on the maximum human body center point feature values respectively corresponding to the human body center point feature sub-maps and the coordinate position information of the maximum human body center point feature values in the human body center point feature map; and
determining, based on the center point position information of each human body bounding box, human body length information and human body width information matching the human body bounding box respectively from the human body length feature map and the human body width feature map comprised in the multichannel feature map, and taking determined human body length information and determined human body width information as the size information of the human body bounding box.

7. The method of claim 6, wherein for the human body center point feature map comprised in the multichannel feature map, successively intercepting human body center point feature sub-maps to be pooled from the human body center point feature map according to the preset pooling size and the preset pooling step size comprises:
performing normalization processing on the human body center point feature map representing a human body center point position by using an activation function, so as to obtain a normalized human body center point feature map; and
successively intercepting the human body center point feature sub-maps to be pooled from the normalized human body center point feature map according to the preset pooling size and the preset pooling step size.

8. The method of claim 6, wherein determining the center point position information of the human body bounding box corresponding to at least one human body based on the maximum human body center point feature values respectively corresponding to the human body center point feature sub-maps and the coordinate position information of the maximum human body center point feature values in the human body center point feature map comprises:
for each of the human body center point feature sub-maps, determining whether the maximum human body center point feature value corresponding to the human body center point feature sub-map is greater than a preset threshold value;
in a case where the maximum human body center point feature value corresponding to the human body center point feature sub-map is greater than the preset threshold value, determining a human body center point indicated by the maximum human body center point feature value as a target human body center point; and
determining the center point position information of the human body bounding box corresponding to at least one human body based on coordinate position information of each target human body center point in the human body center point feature map.

9. The method of claim 1, wherein the seat belt detection information comprises seat belt bounding box information; and performing seat belt detection on the vehicle cabin environment image to obtain the seat belt detection information of the at least one seat belt in the vehicle cabin comprises:
generating a vehicle cabin feature map based on the vehicle cabin environment image;
determining seat belt category information of each of a plurality of pixel points comprised in the vehicle cabin feature map, wherein the seat belt category information comprises indication whether or not the pixel point belongs to the seat belt;
determining, a pixel point of which the seat belt category information indicates that the pixel point belongs to the seat belt, as a target seat belt pixel point;
determining information of a relative offset between each target seat belt pixel point and a seat belt center pixel point;
determining the seat belt center pixel point corresponding to each target seat belt pixel point based on the information of the relative offset; and
clustering a plurality of target seat belt pixel points corresponding to a same seat belt center pixel point based on the seat belt center pixel point, so as to obtain the seat belt bounding box information corresponding to at least one seat belt in the vehicle cabin, wherein the seat belt bounding box information comprises center point detection information of a seat belt bounding box.

10. The method of claim 9, wherein determining the seat belt category information of each of the plurality of pixel points comprised in the vehicle cabin feature map comprises:
performing seat belt detection on the vehicle cabin feature map to obtain a two-channel feature map, wherein the two-channel feature map comprises a background feature map and a seat belt feature map; and
for each of the plurality of pixel points comprised in the vehicle cabin feature map, determining, as the seat belt category information of the pixel point, seat belt category information indicated by a larger feature value of feature values respectively corresponding to the pixel point in the background feature map and the seat belt feature map.

11. A seat belt wearing detection apparatus, comprising:
a memory storing processor-executable instructions; and
a processor configured to execute the processor-executable instructions to perform operations of:
acquiring a vehicle cabin environment image;
performing detection on the vehicle cabin environment image to obtain human body detection information of at least one human body in a vehicle cabin, and to perform seat belt detection on the vehicle cabin environment image to obtain seat belt detection information of at least one seat belt in the vehicle cabin;
matching the human body detection information of the at least one human body with the seat belt detection information of at least one seat belt, and determine a seat belt wearing detection result; and
sending alarm information in a case where any human body is not wearing a seat belt.

12. The apparatus of claim 11, wherein matching the human body detection information of the at least one human body with the seat belt detection information of the at least one seat belt comprises:
determining information of a relative offset between a center point position of a seat belt bounding box corresponding to the at least one seat belt and a center point position of a human body bounding box; and
searching whether there is a center point of the human body bounding box associated with the center point of the seat belt bounding box corresponding to each seat belt among center point of the human body bounding box corresponding to the at least one human body based on determined information of the relative offset.

13. The apparatus of claim 12, wherein determining the seat belt wearing detection result comprises:
for any human body, in a case where there is no center point of the seat belt bounding box associated with the center point of the human body bounding box corresponding to the human body, determining that the human body is not wearing the seat belt.

14. The apparatus of claim 12, wherein determining the seat belt wearing detection result comprises o:
for any human body, in a case where there is a center point of the seat belt bounding box associated with the center point of the human body bounding box corresponding to the human body, determining that the human body is wearing the seat belt.

15. The apparatus of claim 11, wherein the human body detection information comprises human body bounding box information; and performing detection on the vehicle cabin environment image to obtain the human body detection information of the at least one human body in the vehicle cabin comprises:
generating a vehicle cabin feature map based on the vehicle cabin environment image;
performing human body detection on the vehicle cabin feature map to obtain a multichannel feature map corresponding to each of at least one human body in the vehicle cabin, wherein the multichannel feature map comprises a human body center point feature map, a human body length feature map, and a human body width feature map; and
determining the human body bounding box information corresponding to the at least one human body based on the multichannel feature map, wherein the human body bounding box information comprises center point position information of the human body bounding box and size information of the human body bounding box.

16. The apparatus of claim 15, wherein determining the human body bounding box information corresponding to the at least one human body based on the multichannel feature map comprises:
for the human body center point feature map comprised in the multichannel feature map, successively intercepting human body center point feature sub-maps to be pooled from the human body center point feature map according to a preset pooling size and a preset pooling step size;
for each of the human body center point feature sub-maps intercepted successively, performing maximum pooling processing on the human body center point feature sub-map, and determining a maximum human body center point feature value of respective human body center point feature values corresponding to the human body center point feature sub-map, and coordinate position information of the maximum human body center point feature value in the human body center point feature map;
determining the center point position information of the human body bounding box corresponding to at least one human body based on the maximum human body center point feature values respectively corresponding to the human body center point feature sub-maps and the coordinate position information of the maximum human body center point feature values in the human body center point feature map; and
determining, based on the center point position information of each human body bounding box, human body length information and human body width information matching the human body bounding box respectively from the human body length feature map and the human body width feature map comprised in the multichannel feature map, and taking determined human body length information and determined human body width information as the size information of the human body bounding box.

17. The apparatus of claim 16, wherein for the human body center point feature map comprised in the multichannel feature map, successively intercepting human body center point feature sub-maps to be pooled from the human body center point feature map according to the preset pooling size and the preset pooling step size comprises:
performing normalization processing on the human body center point feature map representing a human body center point position by using an activation function, so as to obtain a normalized human body center point feature map; and
successively intercepting the human body center point feature sub-maps to be pooled from the normalized human body center point feature map according to the preset pooling size and the preset pooling step size.

18. The apparatus of claim 16, wherein determining the center point position information of the human body bounding box corresponding to at least one human body based on the maximum human body center point feature values respectively corresponding to the human body center point feature sub-maps and the coordinate position information of the maximum human body center point feature values in the human body center point feature map comprises:
for each of the human body center point feature sub-maps, determining whether the maximum human body center point feature value corresponding to the human body center point feature sub-map is greater than a preset threshold value;
in a case where the maximum human body center point feature value corresponding to the human body center point feature sub-map is greater than the preset threshold value, determining a human body center point indicated by the maximum human body center point feature value as a target human body center point; and
determining the center point position information of the human body bounding box corresponding to at least one human body based on coordinate position information of each target human body center point in the human body center point feature map.

19. The apparatus of claim 11, wherein the seat belt detection information comprises seat belt bounding box information; and performing seat belt detection on the vehicle cabin environment image to obtain the seat belt detection information of the at least one seat belt in the vehicle cabin comprises:
generating a vehicle cabin feature map based on the vehicle cabin environment image;
determining seat belt category information of each of a plurality of pixel points comprised in the vehicle cabin feature map, wherein the seat belt category information comprises indication whether or not the pixel point belongs to the seat belt;
determining, a pixel point of which the seat belt category information indicates that the pixel point belongs to the seat belt, as a target seat belt pixel point;
determining information of a relative offset between each target seat belt pixel point and a seat belt center pixel point;
determining the seat belt center pixel point corresponding to each target seat belt pixel point based on the information of the relative offset; and
clustering a plurality of target seat belt pixel points corresponding to a same seat belt center pixel point based on the seat belt center pixel point, so as to obtain the seat belt bounding box information corresponding to at least one seat belt in the vehicle cabin, wherein the seat belt bounding box information comprises center point detection information of the seat belt bounding box.

20. A non-transitory computer readable storage medium having stored thereon computer-executable instructions that, when executed by a processor, cause the processor to perform operations of:
acquiring a vehicle cabin environment image;
performing detection on the vehicle cabin environment image to obtain human body detection information of at least one human body in a vehicle cabin, and performing seat belt detection on the vehicle cabin environment image to obtain seat belt detection information of at least one seat belt in the vehicle cabin;
matching the human body detection information of the at least one human body with the seat belt detection information of the at least one seat belt, and determining a seat belt wearing detection result; and
in a case where any human body is not wearing a seat belt, sending alarm information.
